(19) United States
(12) Patent Application Publication
(10) Pub. No.: US 2026/0170298 A1
(43) Pub. Date: Jun. 18, 2026

(54) SEQUENTIAL MODEL PIPELINES FOR SIMULATING DEPENDENT PREDICTION CHAINS

(71) Applicant: Optum Services (Ireland) Limited, Dublin (IE)

(72) Inventors: James McNair SLOAN, Bathgate (GB); Breanndan O CONCHUIR, Kerry (IE); Matthew ROBINSON, Greystones (IE); Saurabh GOEL, Naas (IE)

(21) Appl. No.: 18/980,928

(22) Filed: Dec. 13, 2024

(51) Int. Cl. G06N 3/045; G06N 3/09

(52) U.S. Cl. CPC G06N 3/045; G06N 3/09

(57) ABSTRACT

Various examples of the present disclosure utilize a sequential model pipeline to predict time-based effect output that improves the functionality of a computer in various aspects. The techniques comprise receiving a labeled output comprising a historical ground truth cause label and a historical ground truth effect label, generating a time-based cause output using a first machine learning model of the sequential model pipeline, generating a time-based effect output using a second machine learning model of the sequential model pipeline, and initiating a performance of a prediction-based action based on the time-based effect output.

### CROSS REFERENCE TO RELATED APPLICATIONS

This application is related to application Ser. No. 18/980,308, entitled Connected Model Framework for Forecasting Causal Predictions, filed Dec. 13, 2024, the content of which is incorporated herein for all purposes.

### BACKGROUND

Various embodiments of the present disclosure address technical challenges related to machine learning technology, such as the application of machine learning in simulating future events. In various domains, a supervised machine learning model may be trained to forecast an event based on input data. To do so, the supervised models may be trained using a labeled dataset that comprises a ground truth and a set of features predictive of the ground truth. Using the labeled dataset, a supervised model may be trained to correlate the set of features to a particular class as indicated by the ground truth. Traditionally, the performance of such models is correlated with the predictiveness of the set of features to target classes of the model.

Traditional supervised machine learning models have two primary requirements: (1) a training dataset representing a correlation between predictive features and ground truths for target classes and (2) a capability of reconstructing at least a portion of the predictive features as input to the machine learning model during inference. This dual requirement of requiring labeled data for training that matches data available during inference limits the design of training datasets for supervised machine learning models by narrowing the available training features to those that would be available during inference. This presents several technical challenges that reduce the efficacy (e.g., in terms of accuracy) of supervised machine learning when applied to simulations in which predictive features most predictive of a particular class are unavailable.

### BRIEF DESCRIPTION OF THE DRA WINGS

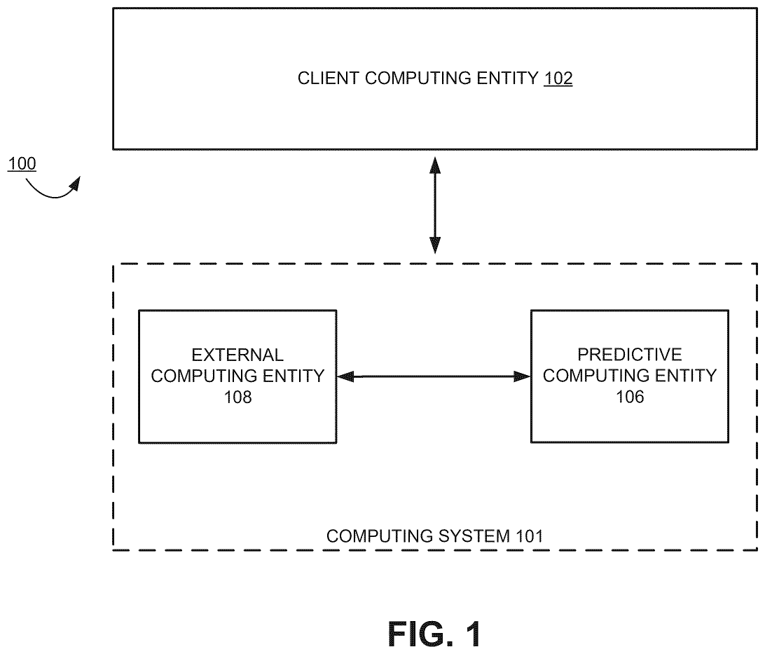

FIG. 1 depicts a block diagram of an example architecture in accordance with some embodiments of the present disclosure.

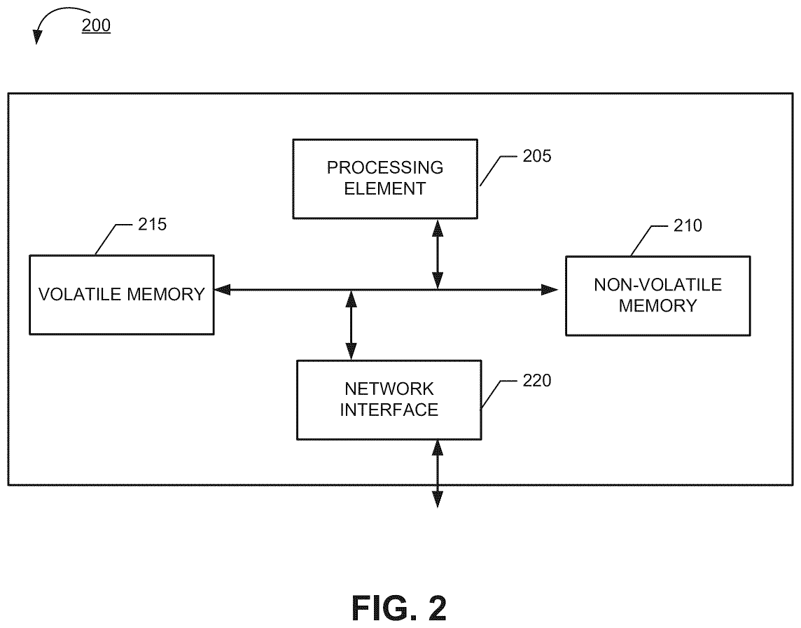

FIG. 2 depicts a block diagram of an example predictive data analysis computing entity in accordance with some embodiments of the present disclosure.

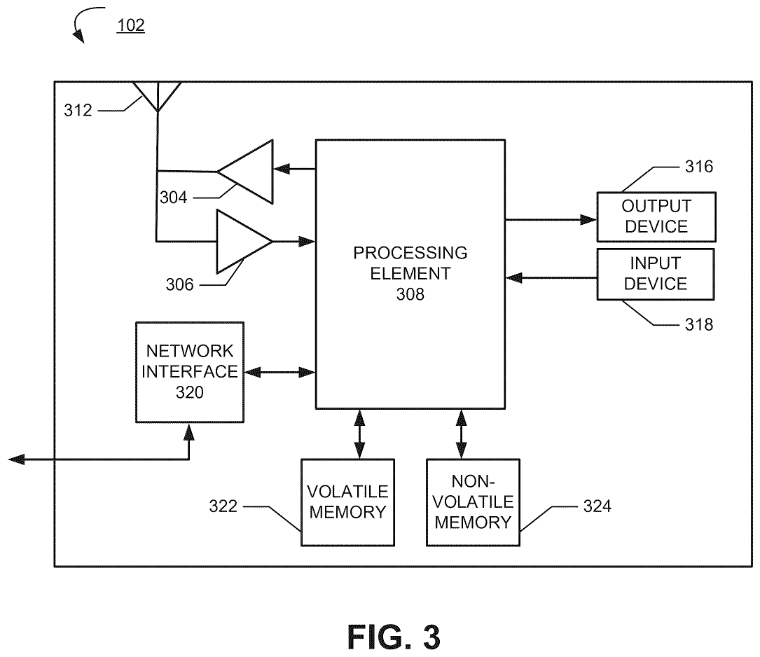

FIG. 3 depicts a block diagram of an example client computing entity in accordance with some embodiments of the present disclosure.

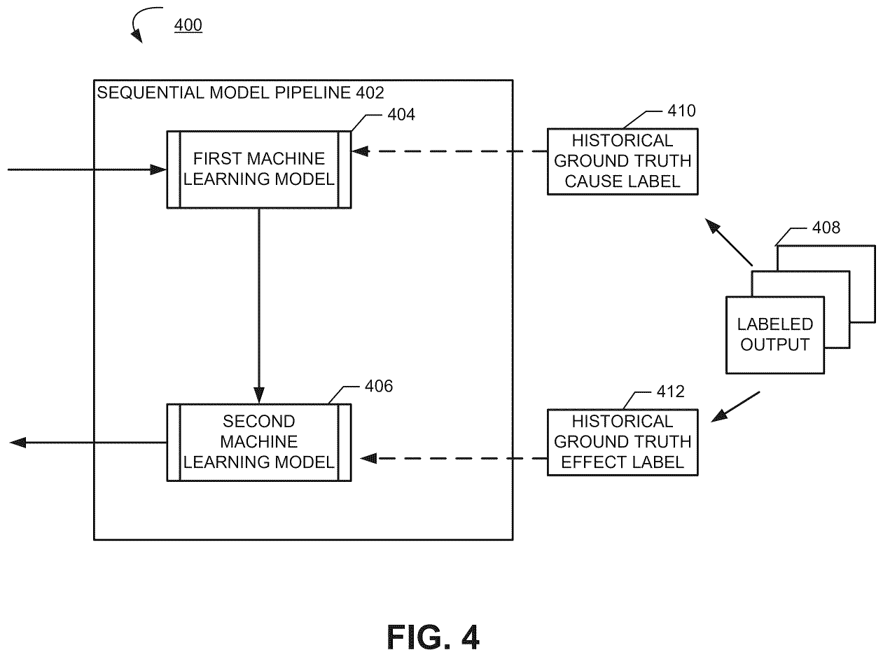

FIG. 4 depicts a dataflow diagram illustrating example training and inference operations of a sequential model pipeline in accordance with some embodiments of the present disclosure.

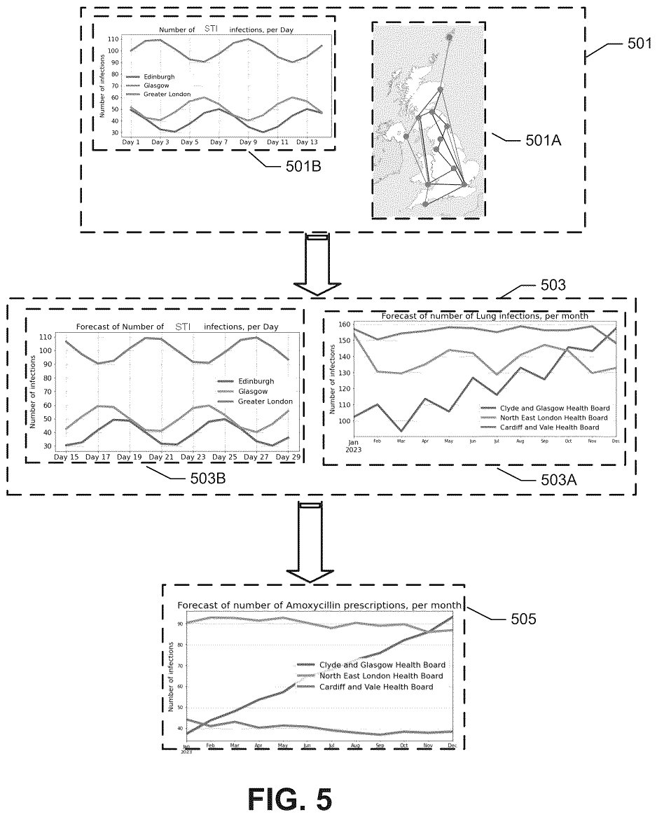

FIG. 5 depicts an operational example of generating a time-based effect output using a sequential model pipeline in accordance with some embodiments of the present disclosure.

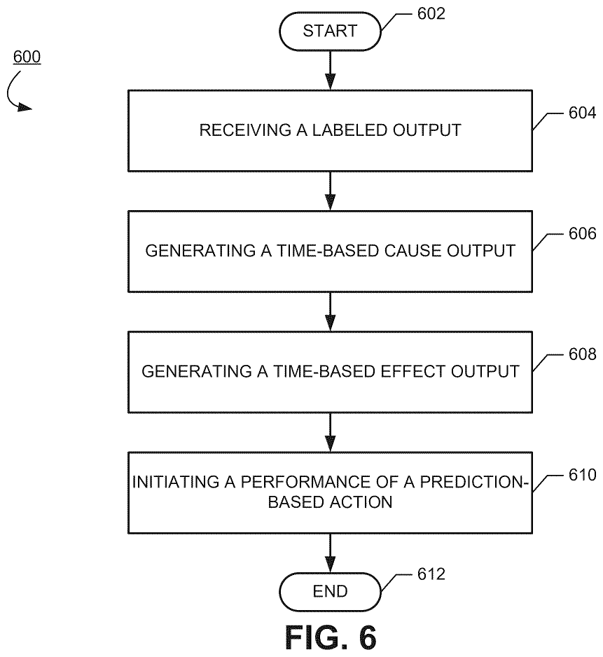

FIG. 6 depicts a flowchart diagram of an example process generating a time-based effect output in accordance with some embodiments of the present disclosure.

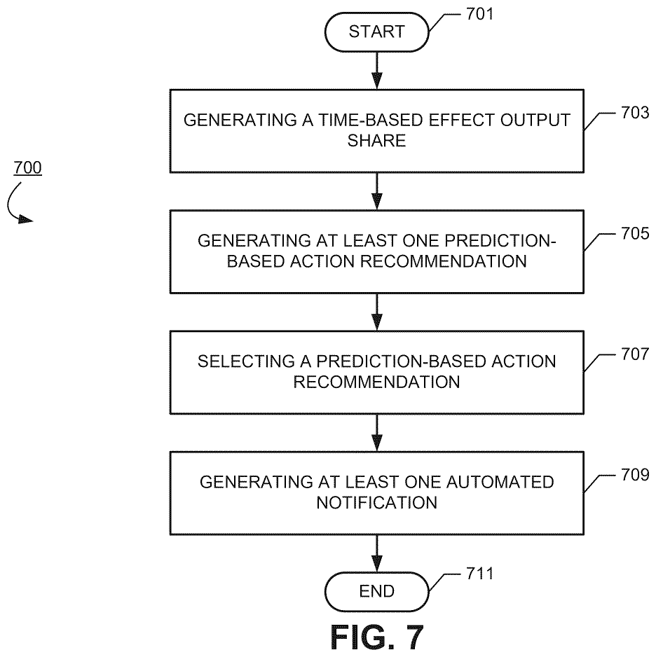

FIG. 7 depicts an operational example of initiating a performance of a prediction-based action in accordance with some embodiments of the present disclosure.

### DETAILED DESCRIPTION

Various embodiments of the present disclosure provide machine learning pipelines that improve the functionality of a computer with respect to various computing tasks, such as computer simulation technology. To do so, some embodiments of the present disclosure provide a sequential model pipeline that defines a plurality of complementary machine learning stages configured to simulate and then classify predictive features for future time points in which features most predictive of a particular class are unavailable. For example, the sequential model pipeline may address challenges with supervised machine learning by connecting multiple models within a single pipeline in which predictions of a preceding model may be fed in as features of a subsequent model. For instance, sequential model pipeline may comprise a first machine learning model, such as a graph neural network, that is trained, based on a first set of features, to generate a first time-based output that is reflective of predicted state within a future environment. The sequential model pipeline may forward the time-based output, as one of a second set of features, to a second machine learning model, such as a machine learning classifier, that is trained based on the second set of features to generate a second time-based output that is dependent on the first. In this way, the sequential model pipeline may enable dependent prediction chains that may expand the applicability of supervised machine learning to use cases with limited feature data, such as simulations of a future environment.

More particularly, some embodiments of the present disclosure present improved machine learning techniques that enable supervised machine learning training using predictive features that may be unavailable at inference. As described herein, traditional supervised machine learning approaches are indirectly limited by the efficacy of predictive features available at inference. To overcome these challenges, the sequential model pipeline of the present disclosure breaks a complex prediction into a dependent prediction chain with predictions that are individually predictable using different machine learning architectures. A first architecture, such as a graph neural network for example, may provide improved performance with respect to predictions of a future environment based on a preceding state of the environment. In addition, or alternatively, a second architecture, such as a machine learning classifier, may leverage predictions of the future environment to generate a target prediction for the future environment that is unaccounted for by the first architecture. In this way, the sequential model pipeline enables training techniques for supervised model architectures that benefit from the most predictive features of a target class regardless of the availability of the predictive features during inference. By doing so, the sequential model pipeline of the present disclosure may leverage trained machine learning classifiers with other architectures to extend the simulation capabilities of a computer.

In addition, or alternatively, some embodiments of the present disclosure present automation frameworks that integrate simulation technology, for example as implemented through connected machine learning models, with the real world through reinforcement learning. For example, the sequential model pipeline may connect the machine learning models of the present disclosure to downstream rule-based model and/or automated systems configured to initiate an action based on the predictions of the machine learning models. The rule-based models, for example, may comprise causal models with dependent variables that depend on a future state of an environment. To apply such models to a simulated future, the sequential model pipeline may feed the predictions of the preceding machine learning models to the causal models as dependent variables. In this manner, causal models may be developed and applied to future states to allow for the automation of previously manual tasks. In some examples, the causal models may further provide inputs to a downstream automation model that may be trained, using reinforcement learning techniques, to implement an action that optimizes the future state of an environment. In this manner, the sequential model pipeline may integrate a series of different model architectures into a single cohesive unit that improves both simulation accuracy and the automaton of simulation-based actions within a real-world environment.

Examples of technologically advantageous embodiments of the present disclosure comprise an improved distribution of machine learning functionality within a simulation system that extends the capabilities of traditional machine learning techniques among other aspects of the present disclosure. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

FIG. 1 depicts a block diagram of an example architecture 100 in accordance with some embodiments of the present disclosure. The architecture 100 comprises a computing system 101 configured to receive a request, such as a time-based effect output prediction request, and/or the like, from client computing entities 102, process the time-based effect output prediction request, and provide the time-based effect output to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learning models may be trained to generate candidate outputs, candidate output scores, and/or other machine learning outputs. The models may be adapted to a differential request handling engine and/or complementary scoring mechanism that may collectively process a request using a modular model ensemble. Some techniques of the present disclosure may adapt traditional models to a cohesive framework, such as the modular model ensemble, for more efficient handling of portions of the request handling process.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., request handling, scoring techniques, prediction techniques, and/or the like) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as labeled output of a historical temporal sequence of labeled outputs to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile memory 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data May be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entities 102, the computing system 101, the predictive computing entity 106, and/or the external computing entities 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to computer simulation technology. In particular, systems and methods are disclosed herein that implement a sequential model pipeline that defines a plurality of complementary machine learning stages configured to simulate and then classify predictive features for future time points in which features most predictive of a particular class are unavailable. By doing so, the sequential model pipeline may enable dependent prediction chains that may expand the applicability of supervised machine learning to use cases with limited feature data, such as simulations of a future environment. This, in turn, may improve the functionality of a computer with respect to various computing tasks, comprising computer simulation, further event prediction, and the like.

FIG. 4 depicts a dataflow diagram 400 of example training and inference operations of a sequential model pipeline in accordance with some embodiments of the present disclosure. For example, the dataflow diagram 400 highlights training machine learning models in the sequential model pipeline 402 based on the labeled output 408. Through training, the machine learning models in the sequential model pipeline 402 refine parameters by iterative learning from the labeled output 408, improving accuracy and robustness of machine learning models in the sequential model pipeline 402 while enhancing the predictive capabilities of machine learning models in the sequential model pipeline 402 in generating time-based predictions.

In some embodiments, a time-based prediction is a predictive class in which historical insights are used to infer future predictions. For example, a time-based prediction may be associated with a historical temporal sequence of events that may be used to train machine learning models to forecast future outcomes, events, values, and/or the like in the prediction temporal sequence. For example, machine learning models may analyze patterns, trends, dependence, and/or the like based on data from a historical temporal sequence to generate predictions about future time points.

In some embodiments, a historical temporal sequence is a time series dataset of chronological data points and/or events that are associated with a time-based prediction. In some embodiments, a data point in the historical temporal sequence is associated with a historical time position that indicates a position in time of the data point in the historical temporal sequence. By way of example, a historical temporal sequence of labeled outputs may comprise a series of labeled outputs that respectively correspond to a series of historical timepoints.

In some embodiments, a labeled output may comprise a data object that is assigned a specific identifier, annotation, and/or tag corresponding to a predefined category and/or value. For example, an example labeled output may comprise one or more labels for a time-based prediction that correspond to a particular historical time point within a historical temporal sequence. The labeled output 408, for example, may comprise a historical ground truth cause label 410 and/or a historical ground truth effect label 412.

In some embodiments, a historical ground truth cause label 410 is a label assigned to a data point that identifies and/or represents a verified or true cause or origin of an observed outcome at a particular historical time point. For example, the historical ground truth cause label 410 may identify a causal factor for a historical ground truth effect label 412. The causal factors, for example, may depend on a prediction domain. In a clinical domain, for example, a causal factor may comprise a disease rate within a population that triggers medication prescriptions.

In some embodiments, a historical cause occurrence attribute is an attribute of an example historical ground truth cause label 410 that indicates and/or represents the frequency, presence, and/or characteristic of a specific cause in the historical ground truth cause label 410.

In some embodiments, the historical ground truth effect label 412 is a label assigned to a data point that identifies a verified and/or true outcome or result of an observed cause in the past. For example, an example historical ground truth effect label 412 may represent the effect and/or impact that a data point in the historical ground truth cause label 410 has at least indirectly caused.

In some embodiments, the historical effect occurrence attribute is an attribute of an example historical ground truth effect label 412 that indicates and/or represents a frequency, presence, and/or characteristic of a specific outcome in the historical ground truth effect label 412.

In some embodiments, the historical ground truth cause label 410 and/or the historical ground truth effect label 412 is associated with different time positions in the historical temporal sequence. For example, the historical ground truth cause label 410 may be associated with a first historical time position. In addition, or alternatively, the historical ground truth effect label 412 may be associated with a second historical time position. In some embodiments, the second historical time position is subsequent to the first historical time position.

In some embodiments, the sequential model pipeline 402 is an ordered series of stages in the machine learning model architecture in which the output from one stage serves as the input to the next stage. By doing so, the sequential model pipeline 402 of the present disclosure may break a complex prediction into a dependent prediction chain with predictions that are individually predictable using different machine learning architectures, leveraging trained machine learning classifiers with other architectures to extend the simulation capabilities of a computer.

In some embodiments, the sequential model pipeline 402 comprises one or more machine learning models. For example, the sequential model pipeline 402 may comprise a first machine learning model 404 and a second machine learning model 406. In some examples, the output from the first machine learning model 404 may be provides as input to the second machine learning model 406.

In some embodiments, the first machine learning model comprises a machine learning model of the sequential model pipeline 402 that is configured to generate a time-based cause output and/or provide the time-based cause output to the second machine learning model 406 of the sequential model pipeline 402. In some embodiments, the first machine learning model 404 may comprise a graph neural network. By way of example, one such graph neural network may comprise a portion of a connected model framework as described in U.S. patent application Ser. No. 18/980,308, which incorporated by reference herein for all purposes.

In some embodiments, the graph neural network comprises a type of neural network architecture that is configured to operate on graph-structure data where data points may be represented as nodes and/or their relationships to one another may be represented as edges. In some embodiments, an example graph neural network may comprise at least one graph processing layer.

In some embodiments, a graph processing layer comprises a computation unit within an example graph neural network that operates on graph-based data to transform graph features (such as nodes, edges, and/or attributes thereof) into embedded representations. In some examples, a graph processing layer may aggregate data and/or information from neighboring nodes and edges. In some examples, the example graph processing layer may process input feature representations using operations such as, attention, recurrent transformation, and/or the like, to generate new feature representations that capture the structural and/or relational data associated with the data points in the graph-structure data. In some examples, one or more graph processing layer of the graph neural network may be stacked and/or combined to form the architecture of the graph neural network.

In some embodiments, a graph layer learnable parameter is a value, property, and/or learnable coefficient associated with a graph processing layer of a graph neural network that is trainable and may be optimized during the training process to enable the graph neural network to analyze the input feature representations. For example, an example graph layer learnable parameter may be in the form of a trainable weight within a graph processing layer of a graph neural network. In some examples, the graph layer learnable parameter may comprise weight matrices, attention coefficients, and/or the like.

In some embodiments, the first machine learning model 404 may be trained based on the historical ground truth cause label 410. For example, the first machine learning model 404 may collect and/or preprocess the historical ground truth cause label 410 by encoding and/or normalizing numerical features from the historical ground truth cause label 410. Continuing in this example, the first machine learning model 404 may generate a prediction based on the historical ground truth cause label 410 (for example, a predicted time-based cause output), and compare the prediction with the historical data that is labeled with the historical ground truth cause label 410 (for example, a historical time-based cause output) using a loss function. Based on the results from the loss function, the first machine learning model 404 may adjust a graph layer learnable parameter associated with the graph processing layer of the graph neural network to minimize the results from the loss function. Additional details associated with the predicted time-based cause output are described herein.

In some embodiments, the second machine learning model 406 is a machine learning model of the sequential model pipeline 402 that is configured to receive a time-based cause output from the first machine learning model 404 of the sequential model pipeline 402 and/or generate a time-based effect output based on the time-based cause output. In some embodiments, the second machine learning model 406 comprises a supervised machine learning model, such as a machine learning classifier.

In some embodiments, the supervised machine learning model is a type of predictive machine learning model that is trained using a training dataset that comprises input labels paired with output labels. For example, a supervised machine learning model may learn to map input feature representations to output feature representations by identifying patterns, relationships, and/or dependencies associated with the data. In some embodiments, a machine learning classifier may comprise a type of supervised machine learning model that is trained to categorize input data into predefined classes and/or categories.

In some embodiments, the second machine learning model 406 comprises one or more computation layers (e.g., tokenizers, embedding layers, encoding layer, attention layers). A computation layer, for example, may comprise a functional unit and/or module within a supervised machine learning model, such as a machine learning classifier, that performs transformations on input data to extract features, learn patterns, generate predictions, and/or the like. In some examples, one or more computation layers of a supervised machine learning model may be stacked and/or combined to form the architecture of the supervised machine learning model.

In some embodiments, up to each computation layer of the second machine learning model 406 comprises one or more computation layer learnable parameters. A computation layer learnable parameter, for example, may comprise a trainable parameter and/or value within a computation layer of a supervised machine learning model that may be adjusted during training of the supervised machine learning model to minimize prediction errors. For example, the computation layer learnable parameters may comprise weights, biases, attention coefficients, and/or the like.

In some embodiments, the second machine learning model 406 may be trained based on the historical ground truth effect label 412. For example, the second machine learning model 406 may collect and/or preprocess historical time-based cause outputs associated with the historical ground truth effect label 412. The second machine learning model 406 may generate a prediction based on the historical time-based cause output (e.g., a predicted time-based effect output), and compare the prediction with the historical ground truth effect label 412 using a loss function. Based on the results from the loss function, the second machine learning model 406 may adjust a computation layer learnable parameter associated with a computation layer of the supervised machine learning model (e.g., machine learning classifier) to minimize the results from the loss function. Additional details associated with the time-based cause output are described herein.

FIG. 5 depicts an operational example 500 of generating a time-based effect output using a sequential model pipeline in accordance with some embodiments of the present disclosure. As shown in the operational example 500, the sequential model pipeline of the present disclosure breaks a complex prediction into a dependent prediction chain with predictions that are individually predictable using a different machine learning architecture. By doing so, the sequential model pipeline of the present disclosure may leverage trained machine learning classifiers with other architectures to extend the simulation capabilities of a computer.

In some examples, inputs to an example sequential model pipeline may comprise ground truth cause labels 501. The ground truth cause labels 501, for example, may comprise a data point that identifies a verified and/or true cause or origin of a future outcome.

In some embodiments, the ground truth cause labels 501 may comprise graph-structure data. For instance, the ground truth cause labels 501 may comprise a historical sequence of labeled outputs for up to each of a set of connected networked locations within a connected environment. In such a case, the historical sequence of labeled outputs may be stored in nodes that correspond to the set of connected networked locations. In some examples, the node may be connected based on network connection between the networked locations.

By way of example, in a clinical domain (e.g., for predicting the demand of medication for treating infections), the ground truth cause labels 501 may comprise data and/or information in the historical temporal sequence such as, travel statistics data 501A (e.g., network interconnectivity data) that provide quantitative and/or qualitative information about movements of entities between geographic locations, regional infections data 501B that provides location-specific information about the number, prevalence and/or trends of a specific infection in the population of a defined geographic area, and/or the like. While the description above provides examples of ground truth cause labels in the healthcare context, it is noted that the scope of the present disclosure is not limited to the description above. In some examples, example ground truth cause labels may comprise one or more additional and/or alternative data and/or information.

In some embodiments, a computing system 101 generates time-based cause outputs 503 using the first machine learning model of the sequential model pipeline. For example, the first machine learning model of the sequential model pipeline may generate the time-based cause outputs 503 based on the ground truth cause labels 501. In some embodiments, the time-based cause output may comprise a forecast and/or prediction that is generated by a machine learning model and/or indicates a predicted cause associated with an event or outcome in the future.

In some embodiments, the time-based cause output is added to a prediction temporal sequence for a time-based prediction. The prediction temporal sequence, for example, may comprise time series data structure that comprises a set of data points and/or events respectively corresponding to a set of future timepoints. In some embodiments, a data point in the prediction temporal sequence is associated with a time position that indicates a position in time of a data point in the prediction temporal sequence. For example, the time-based cause output may be for a first time position in the prediction temporal sequence.

Continuing from the healthcare example above, the time-based cause outputs 503 may comprise predicted infection data. For example, the time-based cause outputs 503 may comprise predicted STI infection data 503B that indicates predicted prevalence and/or trends of STI infection in the future. Additionally, or alternatively, the time-based cause outputs 503 may comprise predicted lung infection data 503A that indicates predicted prevalence and/or trends of lung infection in the future.

In some embodiments, a computing system 101 provides the time-based cause outputs 503 into a second machine learning model of a sequential model pipeline as an input feature for a subsequent prediction. The second machine learning model may generate a time-based effect output 505. The time-based effect output, for example, may comprise a forecast and/or prediction that is generated by machine learning models and/or indicates predicted outcome as a result of one or more predicted causes (e.g., time-based cause outputs 503). In some embodiments, the time-based effect output 505 is for a second time position that is subsequent to the first time position in the prediction temporal sequence.

Continuing from the healthcare example above, the time-based effect output 505 may indicate a prediction and/or forecast on a number and/or a trend of demand for medication for treating infections in the future based on the time-based cause outputs 503. For example, the time-based effect output 505 may indicate a prediction and/or forecast on a number or a trend of demand for Amoxycillin for treating predicted lung infection (e.g., predicted lung infection data 503A) and for treating STI infection (e.g., the predicted STI infection data 503B).

FIG. 6 depicts a flowchart diagram of an example time-based effect output generation process 600 in accordance with some embodiments of the present disclosure. The flowchart diagram depicts a dependent prediction chain that leverages trained machine learning models with different architectures to extend the simulation capabilities of a computer. The process 600 may be implemented by one or more computing devices, entities, and/or systems described herein. For example, via the various steps/operations of the process 600, the computing system 101 may generate a time-based cause output and subsequently generate a time-based effect output based on the time-based cause output. By doing so, the process 600 improves computer functionality by improving both simulation accuracy and the automaton of simulation-based actions within a real-world environment.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 starts at operation 602. In some embodiments, subsequent to operation 602, the process 600 proceeds to operation 604. In some embodiments, the process 600 comprises, at operation 604, receiving a labeled output.

For example, the computing system 101 may receive a labeled output of a historical temporal sequence of labeled outputs for a time-based prediction. The labeled outputs may be used to train the sequential model pipeline (e.g., the first machine learning model of the sequential model pipeline and/or the second machine learning model of the sequential model pipeline).

In some embodiments, the labeled outputs comprise a historical ground truth cause label for a first historical time position and/or a historical ground truth effect label for a second historical time position. The historical ground truth cause label of the labeled outputs may identify and/or represent a verified and/or true cause and/or origin of an observed outcome in the past. The historical ground truth effect label of the labeled outputs may identify and/or represent a verified and/or true outcome and/or result of an observed cause in the past. In some embodiments, the second historical time position is subsequent to the first historical time position. In other words, the verified and/or true outcome represented by the historical ground truth effect label occurred subsequent to the verified and/or true cause represented by the historical ground truth cause label.

In some examples, the process 600 may be implemented in the healthcare context for predicting demand for medication. For example, pharmacy chains may encounter the question of how much and what medication to stock to meet the medication needs of the local population in the local region. To solve this question, the historical ground truth cause label may identify and/or represent historical infection data in the local region, and the historical ground truth effect label may represent historical medication demand record in the local region. Continuing this example, the historical medication demand record may be associated with demand for medication at a time subsequent to the time when infection disease data is recorded.

In some embodiments, the process 600 comprises, at operation 606, generating a time-based cause output. For example, the computing system 101 may generate a time-based cause output for a first time position in a prediction temporal sequence corresponding to the time-based prediction using a first machine learning model of a sequential model pipeline. In some embodiments, the first machine learning model is trained based on the historical ground truth cause label from the labeled output received at operation 604.

In some examples, the time-based cause output may indicate and/or represent a forecast or prediction on a predicted cause associated with an event or outcome in the future. In some embodiments, the first machine learning model of a sequential model pipeline may generate time-based cause output based on ground truth cause labels.

Continuing from the healthcare example above, the first machine learning model may receive ground truth cause labels that comprise travel statistics data that provide quantitative and/or qualitative information about movements of individuals or populations to and from a particular geographic location. The ground truth cause label may also comprise regional infection disease data associated with the particular geographic location that indicates past prevalence and/or trends of a specific infectious disease (for example, STI infections). In such an example, the first machine learning model may generate time-based cause output that represents forecast or prediction associated with the number, prevalence and/or trends of the STI infections within the particular geographic location in the future.

In some embodiments, the process 600 comprises, at operation 608, generating a time-based effect output. For example, the time-based effect output may indicate one or more predicted outcomes as a result of one or more predicted causes from the time-based cause output generated at operation 606. For example, the computing system 101 may generate a time-based effect output for a second time position in the prediction temporal sequence based on the time-based cause output using a second machine learning model of the sequential model pipeline. In some examples, the second machine learning model may be trained based on the historical ground truth effect label of the labeled output received at operation 604.

Continuing from the healthcare example above, multiple diseases may be treated by a single medication. For example, chlamydia and lung infections are both often treated with Amoxycillin. To forecast the number of prescriptions for a given disease, the second machine learning model of the sequential model pipeline may aggregate the number of infections for disease(s) that a particular medication treats. In addition, there is often a discrepancy between the number of people infected and prescriptions issued, which may be due to factors such as, but not limited to, stretched primary and secondary care services (leading to lack of medical attention), symptomless disease (such that the patient is not even aware they are infected), high cost, and/or the like. To address such discrepancy, the computing system 101 may train the second machine learning model (for example, a machine learning classifier) of the sequential model pipeline to forecast the number of medications that will likely be needed in the region based on historical ground truth effect label (for example, recoded medication sales in the region), thereby improving the accuracy in estimating medication demand.

In some embodiments, the process 600 comprises, at operation 610, initiating a performance of a prediction-based action. For example, the computing system 101 may initiate a performance of a prediction-based action based on the time-based effect output generated at operation 610.

Some techniques of the present disclosure enable the generation of action outputs that may be performed to initiate one or more real world actions to achieve real-world effects. The techniques of the present disclosure may be used, applied, and/or otherwise leveraged to generate predictions or forecasts of demand for medication in a region. In some examples, the time-based effect output of the present disclosure may trigger action outputs (e.g., through control instructions) to automate medication inventory updating, ordering, and/or the like. The action outputs may control various aspects of a client device, such as the display, transmission, and/or the like of data reflective of an alert, and/or the like. The alert may be automatically communicated to a user and/or may be used to initiate a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

Referring back to FIG. 6, in some embodiments, subsequent to operation 610, the process 600 proceeds to operation 612 and ends.

FIG. 7 depicts a flowchart diagram of an example prediction-based action process 700 in accordance with some embodiments of the present disclosure. The process 700 may be implemented by one or more computing devices, entities, and/or systems described herein. For example, via the various steps/operations of the process 700, the computing system 101 may generate at least one prediction-based action recommendation and generate at least one automated notification. By doing so, the process 700 improves computer functionality by improving both simulation accuracy and the automaton of simulation-based actions within a real-world environment.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 starts at operation 701. In some embodiments, subsequent to operation 701, the process 700 proceeds to operation 703. In some embodiments, the process 700 comprises, at operation 703, generating a time-based effect output share. The time-based effect output share, for example, may comprise a quantitative representation of how a time-based effect output may be attributed to an individual among all individuals associated with the time-based effect output. For example, the computing system 101 may generate the time-based effect output share based on a time-based effect output and/or a ratio input. In some examples, the ratio input may comprise a value that indicates a percentage of time-based effect output that may be attributed to an individual among all individuals.

Continuing from the healthcare example above, the time-based effect output may indicate a prediction or forecast of a demand of a medication in a geographic region. In such an example, pharmacies in the geographic region may correspond to individuals associated with the time-based effect output as pharmacies may provide medication to the population in the geographic region. Continuing in this example, the computing system 101 may generate the ratio input associated with one pharmacy in the geographic region based on historical data that indicates the pharmacy's share of prescriptions in the geographic region, and/or may generate the ration input by using one or more machine learning models. In this example, the time-based effect output share associated with the one pharmacy may be determined based on the following formula:

$$time - based effect output share for a pharmacy = \frac{forecasted number of prescriptions to be filled by pharmacy in a region}{forecasted number of prescriptions to be filled in a region}$$

In some embodiments, the process 700 comprises, at operation 705, generating at least one prediction-based action recommendation. The prediction-based action recommendation, for example, may comprise a data-driven, actionable suggestion based on machine learning model predictions (e.g., the time-based effect output share and/or the time-based effect output) to guide decision-making.

In some embodiments, the computing system 101 may generate a prediction-based action recommendation by using a set of causal models that receives the time-based effect output and the time-based effect output share. The causal model, for example, may comprise a rule-based model, such as directed acyclic graph, that identifies and/or quantifies cause-and-effect relationships (e.g., edges) between variables (e.g., nodes) in a dataset. For example, a causal model may comprise a set of decision points that map the impact of changes in one variable to other variables. In some examples, the computing system 101 may input the time-based effect output and the time-based effect output share to a set of causal models to generate the prediction-based action recommendation.

Continuing from the healthcare example above, variables that may affect the market share of a pharmacy may comprise, but not limited to, advertisement, location of stores, number of stores, fragmentation of pharmacy market in region, number of competitors, sales price, average competitor price, and/or the like. In such an example, the computing system 101 may input the time-based effect output (which indicates a forecast or prediction of demand of the medication in the region) and the time-based effect output share (which indicates the share of the medication demand in the particular pharmacy) to the set of causal models, which may adjust one or more variables to estimate how a particular invention (for example, action taken by the pharmacy) may increase the market share of the pharmacy with related to a given medication. Example actions may comprise, but not limited to, increased marketing, sales, TV campaign, radio campaign, open a new location, and/or the like.

In some embodiments, the process 700 comprises, at operation 707, selecting a prediction-based action recommendation. For example, the computing system 101 may select the prediction-based action recommendation from the at least one prediction-based action recommendation generated at operation 705 based on a predetermined criteria. For example, the computing system 101 may perform a cost-benefit analysis of outcomes associated with the actions described above in connection with operation 705. Additionally, or alternatively, the computing system 101 may select the prediction-based action recommendation based on other predetermined criteria.

In some embodiments, the process 700 comprises, at operation 709, generating at least one automated notification. The automated notification, for example, may comprise a computer-generated message, alert, and/or action that is triggered by one or more predefined conditions, rules, and/or events. In some embodiments, the computing system 101 may generate the at least one automated notification based on (or in response to) the prediction-based action recommendation selected from operation 707 of FIG. 7.

In some embodiments, the at least one automated notification initiates a delivery based on the time-based effect output, the time-based effect output share, or a time-based effect output share adjustment. In some examples, the time-based effect output share adjustment is an adjusted time-based effect output share after the completion of an action corresponding to the prediction-based action recommendation.

Continuing from the healthcare example above, the time-based effect output may indicate a prediction or forecast of a medication in a geographic region, the time-based effect output share may indicate a prediction or forecast of a medication demand in a specific pharmacy in the geographic region, and the time-based effect output share adjustment may indicate an adjusted prediction or forecast of a medication demand in a specific pharmacy after the completion of an action to increase the pharmacy's market share.

Continuing in this example, the computing system 101 may utilize a reinforcement learning algorithm to manage medication inventory based on the time-based effect output, the time-based effect output share, and/or the time-based effect output share adjustment. In some embodiments, the computing system 101 may utilize the reinforcement learning algorithm to manage the inventory of a signal medication in isolation, and/or may utilize the reinforcement learning algorithm to manage the inventories of all medication in parallel. In some examples, the reinforcement learning algorithm may provide a reward function to optimize medication inventory and shelf space of the pharmacy.

Some techniques of the present disclosure enable the generation of action outputs that may be performed to initiate one or more real world actions to achieve real-world effects. The techniques of the present disclosure may be used, applied, and/or otherwise leveraged to generate predictions or forecasts of demand for medication in a region. In some examples, the automated notification of the present disclosure may trigger action outputs (e.g., through control instructions) to automate medication inventory updating, ordering and/or the like. The action outputs may control various aspects of a client device, such as the display, transmission, and/or the like of data reflective of an alert, and/or the like. The alert may be automatically communicated to a user and/or may be used to initiate a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

Referring back to FIG. 7, in some embodiments, subsequent to operation 709, the process 700 proceeds to operation 711 and ends.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model comprising one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising: receiving, by one or more processors, a labeled output of a historical temporal sequence of labeled outputs for a time-based prediction that comprises a historical ground truth cause label for a first historical time position and a historical ground truth effect label for a second historical time position subsequent to the first historical time position; generating, by the one or more processors and using a first machine learning model of a sequential model pipeline that is trained based on the historical ground truth cause label, a time-based cause output for a first time position in a prediction temporal sequence corresponding to the time-based prediction; generating, by the one or more processors and using a second machine learning model of the sequential model pipeline that is trained based on the historical ground truth effect label, a time-based effect output for a second time position in the prediction temporal sequence based on the time-based cause output; and initiating, by the one or more processors, a performance of a prediction-based action based on the time-based effect output.

Example 2. The computer-implemented method of example 1, wherein the first machine learning model comprises a graph neural network, wherein the graph neural network comprises a graph processing layer, wherein the graph neural network is trained by updating a graph layer learnable parameters associated with the graph processing layer based on the historical ground truth cause label.

Example 3. The computer-implemented method of example 2, wherein the historical ground truth cause label comprises a historical cause occurrence attribute.

Example 4. The computer-implemented method of example 1, wherein the second machine learning model comprises a supervised machine learning model, wherein the supervised machine learning model comprises a computation layer, wherein the supervised machine learning model is trained by updating a computation layer learnable parameter associated with the computation layer based on the historical ground truth effect label.

Example 5. The computer-implemented method of example 4, wherein the historical ground truth effect label comprises a historical effect occurrence attribute.

Example 6. The computer-implemented method of example 1 further comprising: generating, by the one or more processors, a time-based effect output share based on the time-based effect output and a ratio input.

Example 7. The computer-implemented method of example 6 further comprising: generating, by the one or more processors and using a set of causal models that receives the time-based effect output and the time-based effect output share, at least one prediction-based action recommendation; and selecting, by the one or more processors, a prediction-based action recommendation from the at least one prediction-based action recommendation.

Example 8. The computer-implemented method of example 7 further comprising: generating, by the one or more processors, at least one automated notification that initiates a delivery based on the time-based effect output, the time-based effect output share, or a time-based effect output share adjustment based on the prediction-based action recommendation.

Example 9. A system comprising: one or more processors; and one or more memories storing processor-executable instructions that, when executed by the one or more processors, cause the one or more processors to perform operations comprising: receiving, by one or more processors, a labeled output of a historical temporal sequence of labeled outputs for a time-based prediction that comprises a historical ground truth cause label for a first historical time position and a historical ground truth effect label for a second historical time position subsequent to the first historical time position; generating, by the one or more processors and using a first machine learning model of a sequential model pipeline that is trained based on the historical ground truth cause label, a time-based cause output for a first time position in a prediction temporal sequence corresponding to the time-based prediction; generating, by the one or more processors and using a second machine learning model of the sequential model pipeline that is trained based on the historical ground truth effect label, a time-based effect output for a second time position in the prediction temporal sequence based on the time-based cause output; and initiating, by the one or more processors, a performance of a prediction-based action based on the time-based effect output.

Example 10. The system of example 9, wherein the first machine learning model comprises a graph neural network, wherein the graph neural network comprises a graph processing layer, wherein the graph neural network is trained by updating a graph layer learnable parameters associated with the graph processing layer based on the historical ground truth cause label.

Example 11. The system of example 10, wherein the historical ground truth cause label comprises a historical cause occurrence attribute.

Example 12. The system of example 9, wherein the second machine learning model comprises a supervised machine learning model, wherein the supervised machine learning model comprises a computation layer, wherein the supervised machine learning model is trained by updating a computation layer learnable parameter associated with the computation layer based on the historical ground truth effect label.

Example 13. The system of example 12, wherein the historical ground truth effect label comprises a historical effect occurrence attribute.

Example 14. The system of example 9, wherein the operations further comprise: generating, by the one or more processors, a time-based effect output share based on the time-based effect output and a ratio input.

Example 15. The system of example 14, wherein the operations further comprise: generating, by the one or more processors and using a set of causal models that receives the time-based effect output and the time-based effect output share, at least one prediction-based action recommendation; and selecting, by the one or more processors, a prediction-based action recommendation from the at least one prediction-based action recommendation.

Example 16. The system of example 15, wherein the operations further comprise: generating, by the one or more processors, at least one automated notification that initiates a delivery based on the time-based effect output, the time-based effect output share, or a time-based effect output share adjustment based on the prediction-based action recommendation.

Example 17. One or more non-transitory computer-readable media storing processor-executable instructions that, when executed by one or more processors, cause the one or more processors to perform operations comprising: receiving, by one or more processors, a labeled output of a historical temporal sequence of labeled outputs for a time-based prediction that comprises a historical ground truth cause label for a first historical time position and a historical ground truth effect label for a second historical time position subsequent to the first historical time position; generating, by the one or more processors and using a first machine learning model of a sequential model pipeline that is trained based on the historical ground truth cause label, a time-based cause output for a first time position in a prediction temporal sequence corresponding to the time-based prediction; generating, by the one or more processors and using a second machine learning model of the sequential model pipeline that is trained based on the historical ground truth effect label, a time-based effect output for a second time position in the prediction temporal sequence based on the time-based cause output; and initiating, by the one or more processors, a performance of a prediction-based action based on the time-based effect output.

Example 18. The one or more non-transitory computer-readable media of example 17, wherein the first machine learning model comprises a graph neural network, wherein the graph neural network comprises a graph processing layer, wherein the graph neural network is trained by updating a graph layer learnable parameters associated with the graph processing layer based on the historical ground truth cause label.

Example 19. The one or more non-transitory computer-readable media of example 18, wherein the historical ground truth cause label comprises a historical cause occurrence attribute.

Example 20. The one or more non-transitory computer-readable media of example 19, wherein the second machine learning model comprises a supervised machine learning model, wherein the supervised machine learning model comprises a computation layer, wherein the supervised machine learning model is trained by updating a computation layer learnable parameter associated with the computation layer based on the historical ground truth effect label.

Example 21. The computer-implemented method of example 1, wherein the method further comprises training the first machine learning model and the second machine learning model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The system of example 1, wherein the one or more processors are further configured to train the first machine learning model and the second machine learning model.

Example 25. The computing system of example 24, wherein the one or more processors are comprised in a first computing entity; and the first machine learning model and the second machine learning model are trained by one or more other processors comprised in a second computing entity.

Example 26. The one or more non-transitory computer-readable storage media of example 17, wherein the instructions further cause the one or more processors to train the first machine learning model and the second machine learning model.

Example 27. The one or more non-transitory computer-readable storage media of example 26, wherein the one or more processors are comprised in a first computing entity; and the first machine learning model and the second machine learning model are trained by one or more other processors comprised in a second computing entity.

What is claimed is:

1. A computer-implemented method comprising:
receiving, by one or more processors, a labeled output of a historical temporal sequence of labeled outputs for a time-based prediction that comprises a historical ground truth cause label for a first historical time position and a historical ground truth effect label for a second historical time position subsequent to the first historical time position;
generating, by the one or more processors and using a first machine learning model of a sequential model pipeline that is trained based on the historical ground truth cause label, a time-based cause output for a first time position in a prediction temporal sequence corresponding to the time-based prediction;
generating, by the one or more processors and using a second machine learning model of the sequential model pipeline that is trained based on the historical ground truth effect label, a time-based effect output for a second time position in the prediction temporal sequence based on the time-based cause output; and
initiating, by the one or more processors, a performance of a prediction-based action based on the time-based effect output.

2. The computer-implemented method of claim 1, wherein the first machine learning model comprises a graph neural network, wherein the graph neural network comprises a graph processing layer, wherein the graph neural network is trained by updating a graph layer learnable parameters associated with the graph processing layer based on the historical ground truth cause label.

3. The computer-implemented method of claim 2, wherein the historical ground truth cause label comprises a historical cause occurrence attribute.

4. The computer-implemented method of claim 1, wherein the second machine learning model comprises a supervised machine learning model, wherein the supervised machine learning model comprises a computation layer, wherein the supervised machine learning model is trained by updating a computation layer learnable parameter associated with the computation layer based on the historical ground truth effect label.

5. The computer-implemented method of claim 4, wherein the historical ground truth effect label comprises a historical effect occurrence attribute.

6. The computer-implemented method of claim 1 further comprising:
generating a time-based effect output share based on the time-based effect output and a ratio input.

7. The computer-implemented method of claim 6 further comprising:
generating, using a set of causal models that receives the time-based effect output and the time-based effect output share, at least one prediction-based action recommendation; and
selecting, by the one or more processors, a prediction-based action recommendation from the at least one prediction-based action recommendation.

8. The computer-implemented method of claim 7 further comprising:
generating at least one automated notification that initiates a delivery based on the time-based effect output, the time-based effect output share, or a time-based effect output share adjustment based on the prediction-based action recommendation.

9. A system comprising:
one or more processors; and
one or more memories storing processor-executable instructions that, when executed by the one or more processors, cause the one or more processors to perform operations comprising:
receiving a labeled output of a historical temporal sequence of labeled outputs for a time-based prediction that comprises a historical ground truth cause label for a first historical time position and a historical ground truth effect label for a second historical time position subsequent to the first historical time position;
generating, using a first machine learning model of a sequential model pipeline that is trained based on the historical ground truth cause label, a time-based cause output for a first time position in a prediction temporal sequence corresponding to the time-based prediction;
generating, using a second machine learning model of the sequential model pipeline that is trained based on the historical ground truth effect label, a time-based effect output for a second time position in the prediction temporal sequence based on the time-based cause output; and
initiating a performance of a prediction-based action based on the time-based effect output.

10. The system of claim 9, wherein the first machine learning model comprises a graph neural network, wherein the graph neural network comprises a graph processing layer, wherein the graph neural network is trained by updating a graph layer learnable parameters associated with the graph processing layer based on the historical ground truth cause label.

11. The system of claim 10, wherein the historical ground truth cause label comprises a historical cause occurrence attribute.

12. The system of claim 9, wherein the second machine learning model comprises a supervised machine learning model, wherein the supervised machine learning model comprises a computation layer, wherein the supervised machine learning model is trained by updating a computation layer learnable parameter associated with the computation layer based on the historical ground truth effect label.

13. The system of claim 12, wherein the historical ground truth effect label comprises a historical effect occurrence attribute.

14. The system of claim 9, wherein the operations further comprise:
generating a time-based effect output share based on the time-based effect output and a ratio input.

15. The system of claim 14, wherein the operations further comprise:
generating, using a set of causal models that receives the time-based effect output and the time-based effect output share, at least one prediction-based action recommendation; and
selecting a prediction-based action recommendation from the at least one prediction-based action recommendation.

16. The system of claim 15, wherein the operations further comprise:
generating at least one automated notification that initiates a delivery based on the time-based effect output, the time-based effect output share, or a time-based effect output share adjustment based on the prediction-based action recommendation.

17. One or more non-transitory computer-readable media storing processor-executable instructions that, when executed by one or more processors, cause the one or more processors to perform operations comprising:
receiving a labeled output of a historical temporal sequence of labeled outputs for a time-based prediction that comprises a historical ground truth cause label for a first historical time position and a historical ground truth effect label for a second historical time position subsequent to the first historical time position;
generating, using a first machine learning model of a sequential model pipeline that is trained based on the historical ground truth cause label, a time-based cause output for a first time position in a prediction temporal sequence corresponding to the time-based prediction;
generating, using a second machine learning model of the sequential model pipeline that is trained based on the historical ground truth effect label, a time-based effect output for a second time position in the prediction temporal sequence based on the time-based cause output; and
initiating a performance of a prediction-based action based on the time-based effect output.

18. The one or more non-transitory computer-readable media of claim 17, wherein the first machine learning model comprises a graph neural network, wherein the graph neural network comprises a graph processing layer, wherein the graph neural network is trained by updating a graph layer learnable parameters associated with the graph processing layer based on the historical ground truth cause label.

19. The one or more non-transitory computer-readable media of claim 18, wherein the historical ground truth cause label comprises a historical cause occurrence attribute.

20. The one or more non-transitory computer-readable media of claim 17, wherein the second machine learning model comprises a supervised machine learning model, wherein the supervised machine learning model comprises a computation layer, wherein the supervised machine learning model is trained by updating a computation layer learnable parameter associated with the computation layer based on the historical ground truth effect label.
